(19) United States
(12) Patent Application Publication
(10) Pub. No.: US 2021/0197483 A1
(43) Pub. Date: Jul. 1, 2021

(54) VALVE ASSEMBLIES FOR CONDUITS

(71) Applicant: HEWLETT-PACKARD DEVELOPMENT COMPANY, L.P., Spring, TX (US)

(72) Inventor: Nicholas WANG, Vancouver, WA (US)

(73) Assignee: HEWLETT-PACKARD DEVELOPMENT COMPANY, L.P., Houston, TX (US)

(21) Appl. No.: 16/075,185

(22) PCT Filed: Jul. 21, 2017
(86) PCT No.: PCT/US2017/043322

§ 371 Date: Aug. 3, 2018

(51) Int. Cl. B29C 64/393; B29C 64/321; B33Y 10/00; B33Y 30/00; B33Y 50/02

(52) U.S. Cl. CPC B29C 64/393; B29C 64/321; B33Y 50/02; B33Y 30/00; B33Y 10/00

(57) ABSTRACT

In some examples, an apparatus includes a plurality of conduits to transport a material of a three-dimensional (3D) printing system between locations in the 3D printing system. A sensor assembly detects a clogged condition of a first conduit of the plurality of conduits. A valve assembly connected to the plurality of conduits selectively controls flow of the material through the plurality of conduits, the valve assembly controllable to actuate from a first setting to a second setting responsive to the detected clogged condition.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a block diagram of a clog detection and unclogging mechanism in a three-dimensional (3D) printing system, according to some examples.

FIG. 2 is a schematic diagram of a 3D printing system according to some examples.

FIGS. 3A and 3B illustrate a valve assembly according to further examples.

FIGS. 4A-4H illustrate different settings of a valve assembly according to some examples.

FIG. 5 is a block diagram of a 3D printing system according to further examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the ensuing discussion, use of the terms “above,” “below”, “upper,” and “lower” are to allow for ease of explanation when describing elements in the views shown in various figures. Note that depending on the actual orientation of a device or apparatus, the foregoing terms can refer to other relative arrangements other than being higher or lower along a vertical orientation. Such terms can refer to a diagonal relationship, or to an upside-down relationship (where the terms “above,” “below,” “upper,” and “lower” would be reversed from their ordinary meanings).

In a three-dimensional (3D) printing system, a build material can be used to form a 3D object, by depositing the build material as successive layers until the final 3D object is formed. In some examples, a build material can include a powdered build material that is composed of particles in the form of fine powder or granules. The powdered build material can include metal particles, plastic particles, polymer particles, or particles of other materials.

The 3D object can be formed on a build platform of the 3D printing system. Any incidental build material that is not used in forming the 3D object can be passed back to a build material reservoir. The incidental build material can be transported through conduits (e.g., hoses) from the build platform to the build material reservoir. A conduit can refer to any transport path that can be used to transport a build material, or other type of material, from a first location to a second location.

In some cases, due to agglomeration of build material particles, or due to the presence of foreign particles, some of the conduits for transporting the incidental build material can become clogged. In other cases, a large amount of build material particles (even if not agglomerated) may also cause clogging of a conduit. If clogged, the conduits may not be able to properly transport incidental build material away from the build platform.

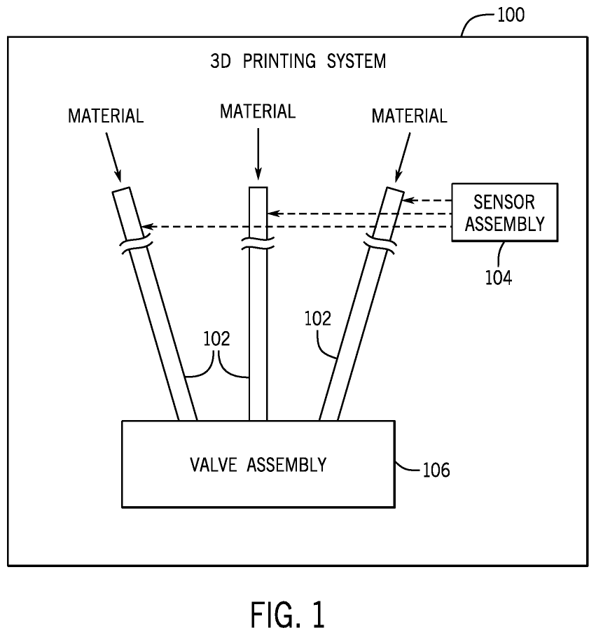

In accordance with some implementations of the present disclosure, as shown in FIG. 1, a clog detection and unclogging mechanism in a 3D printing system 100 is provided to detect a clogged condition of any of multiple conduits 102, and to take action in response to detecting the clogged condition. The conduits 102 are used to transport build material particles using pressurized gas (e.g., pressurized air). The clog detection and unclogging mechanism includes a sensor assembly 104 to detect a clogged condition of a given conduit 102.

In some examples, the sensor assembly 104 includes pressure sensors to sense pressure at points along the respective conduits 102. For example, each pressure sensor can be placed near a location where a build material enters into the respective conduit. In other examples, the pressure sensor can be placed at another location along the respective conduit. If the measured pressure falls outside a specified pressure range, then that can be an indication that the respective conduit is clogged. For example, if a measured pressure is at 0 atmospheres (atm), then that indicates no flow is occurring in the conduit. If the measured pressure is a negative pressure that is below a negative pressure threshold, then that also indicates no flow is occurring in the conduit. A measured pressure between 0 atm and the negative pressure threshold indicates normal operation of the respective conduit (i.e., the respective conduit is not clogged). More generally, if a measured pressure is within a range between P1 and P2, then that indicates normal operation of the respective conduit. However, if the measured temperature falls outside the range between P1 and P2, that indicates that the respective conduit may be clogged.

In other examples, instead of or in addition to using pressure sensors, the sensor assembly 104 can include another type of sensor, such as a flow rate sensor to measure a rate of flow of build material particles in the respective conduit. If the measured flow rate drops below a specified threshold, then that indicates a potential clogged condition of the respective conduit. However, if the measured flow rate is above the specified threshold, then that indicates that the respective conduit is operating normally.

The clog detection and unclogging mechanism further includes a valve assembly 106 connected to the conduits 102 to selectively control flow of the build material in pressurized gas through the conduits 102. The valve assembly 106 is controllable to set the valve assembly 106 in any one of various different settings. In a first setting, the valve assembly 106 allows flow through all of the conduits 102. In a second setting, the valve assembly 106 can allow flow through just one of the conduits 102 (or through a selected subset of the conduits 102), while flow through the remaining conduits 102 is restricted. The valve assembly 106 can be actuated from the first setting to the second setting in response to detecting a clogged condition of a conduit 102 (or multiple conduits 102). Actuating the valve assembly 106 from the first setting to the second setting allows for an increased flow force (e.g., increased draw by a vacuum source or an airflow generator) to be applied to the clogged conduit(s) 102. Applying an increased flow force to the clogged conduit(s) 102 can aid in unclogging the clogged conduit(s) 102.

In the ensuing discussion, reference is made to detecting a clogged condition of a conduit that transports a build material. In other examples, a conduit can be used to transport another type of material, which can be in the form of solid particles or a fluid (such as gas).

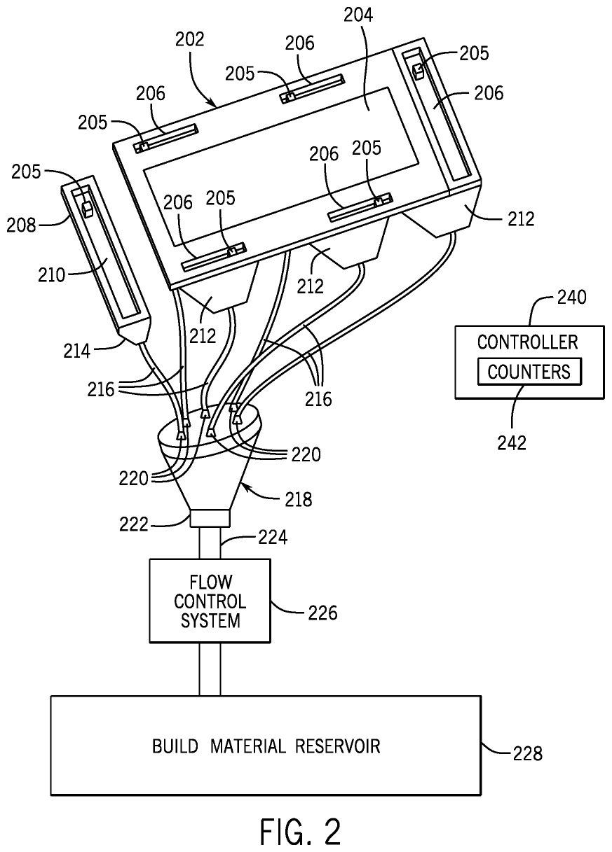

FIG. 2 is a schematic diagram of a portion of a 3D printing system according to some examples. The 3D printing system includes a build platform 202 on which a 3D object can be formed by depositing successive layers of build material onto a build bed 204. The build platform 202 has a generally planar upper surface, on which the build bed 204 is provided. During formation of the 3D object, incidental build material (build material that is not used as part of the 3D printing process) can fall through openings 206 formed in the build platform 202.

Another incidental material receiving structure 208 can be provided on one side and slightly below the build platform 202, to receive any incidental build material that can fall off the print platform 202. The incidental material receiving structure 202 includes an opening 210 through which incidental build material can fall. The incidental build material can pass through respective plenums 212 and 214, which are connected to conduits 216.

Sensors 205 are provided in or near the respective openings 206 and 210, to measure pressure or flow rate at the openings 206 and 210. The sensors 205 can be pressure sensors, flow rate sensors, or other types of sensors that can make measurements for determining whether or not a corresponding conduit 216 is clogged. The sensors 205 can be part of the sensor assembly 104 of FIG. 1.

The conduits 216 are used to transport the incidental build material from the respective plenums 212 and 214 to a valve assembly 218. The valve assembly has multiple valve ports 220 to which the conduits 216 are attached. Incidental build material can flow through the conduits 216 and the valve ports 220. The valve assembly 218 is able to selectively control whether the valve ports 220 are open or closed (or more generally, at a restricted flow position). A restricted flow position can refer to a position where the valve port is closed (i.e., no fluid flow occurs through the valve port 220) or the valve port is partially open (i.e., the valve port is not fully open such that the flow through the valve port is restricted as compared to the flow through the valve port when in the fully open position).

In one setting, the valve assembly 218 can open all the valve ports 220. In another setting, the valve assembly 218 can close all the valve ports 220 (or set all the valve ports to a restricted flow position). The valve assembly 218 also has other settings in which a first subset of the valve ports 220 are open while the remaining valve ports 220 are in a restricted flow position. For example, the valve assembly 218 can set one valve port 220 to the fully open position, while the remaining valve ports 220 are set in a restricted flow position.

An output port 222 of the valve assembly 218 is connected to an output conduit 224. Assuming at least one valve port 220 is open, a build material can flow through a respective conduit 216 (or multiple conduits 216) through the valve assembly 218 and the output port 222 to the output conduit 224.

A flow control system 226 is provided to cause the build material to flow through the output conduit 224 and into a build material reservoir 228. In some examples, the flow control system 226 can include a vacuum source, which is to draw down pressure such that a flow is induced through the output conduit 224. In different examples, the flow control system 226 includes an airflow generator, such as a fan.

Although FIG. 2 shows the flow control system 226 positioned between the valve assembly 218 and the build material reservoir 228, the flow control system 226 can either be located upstream of the valve assembly 218 or downstream of the build material reservoir 228 in other examples. In such alternative arrangements, a filter and air-powder separator can be provided between the build material reservoir 228 and the flow control system 226 to separate air from the build material.

In some examples, the build platform 202 is a removable build platform, which can be removed from the 3D printing system. In other examples, the build platform 202 is integrally fixed into the 3D printing system. In further examples, the build platform 202 and the flow control system 226 (as well as the flow control system 226, the valve assembly 218, and the conduits 216) can be part of a removable subsystem that can be removed from the 3D printing system. Alternatively, the build platform 202, the flow control system 226, the valve assembly 218, and the conduits 216 are fixed in the 3D printing system. More generally, any component or combination of components of the 3D printing system can be removable or fixed.

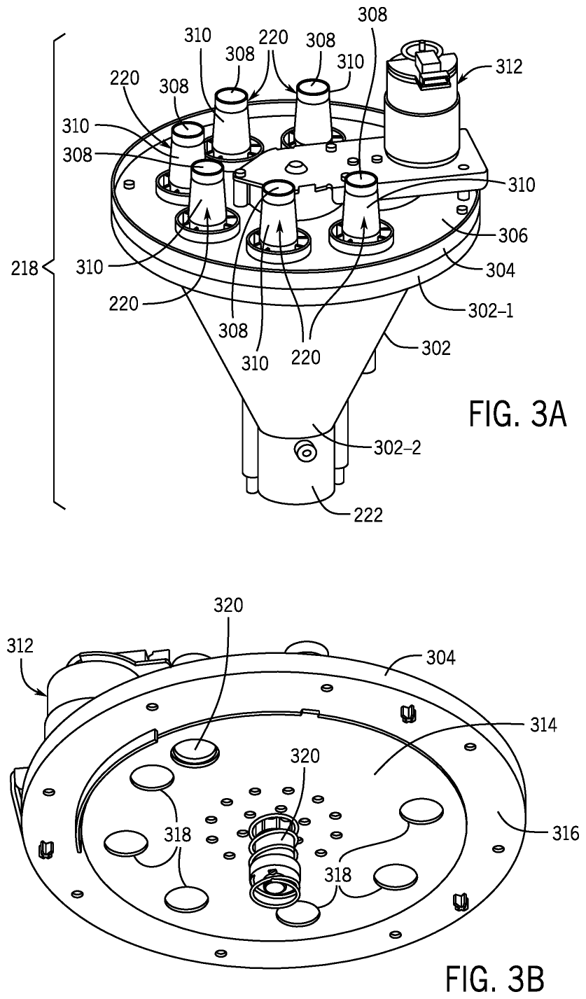

FIG. 3A is a top perspective view of the valve assembly 218, and FIG. 3B is a bottom perspective view of a port structure 304 of the valve assembly 218. As shown in FIG. 3A, the valve assembly 218 includes a funnel 302 and the port structure 304. The funnel 302 is to direct build material received at the valve ports 220 to the output port 222. The funnel 302 has wide side 302-1 and a narrow side 302-2. The wide side 302-1 is attached to the port structure 304, and the narrow side 302-1 leads to the output port 222.

The port structure 304 has an upper surface 306. The valve ports 220 extend above the upper surface 306 of the port structure 304. Each valve port 220 has an input opening 308 defined by tubular inserts 310. The conduits 216 (FIG. 2), which can be in the form of hoses, for example, can fit over the tubular inserts 310 to engage with the valve ports 220. Build material flowing in each conduit 216 can enter the respective valve port 220 through the corresponding input opening 308.

The port structure 304 also includes a motor 312 that is used for moving a valve control member to control the open/close status of each of the valve ports 220.

In FIG. 3B, the valve control member that can be used to control the open/close status of the valve ports 220 is in the form of a rotatable isolation plate 314. The isolation plate 314 is generally circular in shape, and is located below a lower surface 316 of the port structure 304. The isolation plate 314 has various openings 318 and 320. The openings 318 when aligned with the valve ports 220 can set all of the valve ports 220 to the open position. The opening 320 is used to selectively open just one of the valve ports 220, while maintaining the remaining valve ports 220 in the closed position.

The isolation solution plate 314 is attached to a rotatable rod 320. The rotatable rod 320 can be driven by the motor 312. When the rotatable rod 320 is rotated by the motor 312, the isolation plate 314 also rotates correspondingly.

In other examples, instead using a rotatable isolation plate that is circular in shape, the isolation plate can have a different shape. Also, the isolation plate can be translated in a linear direction rather than rotated.

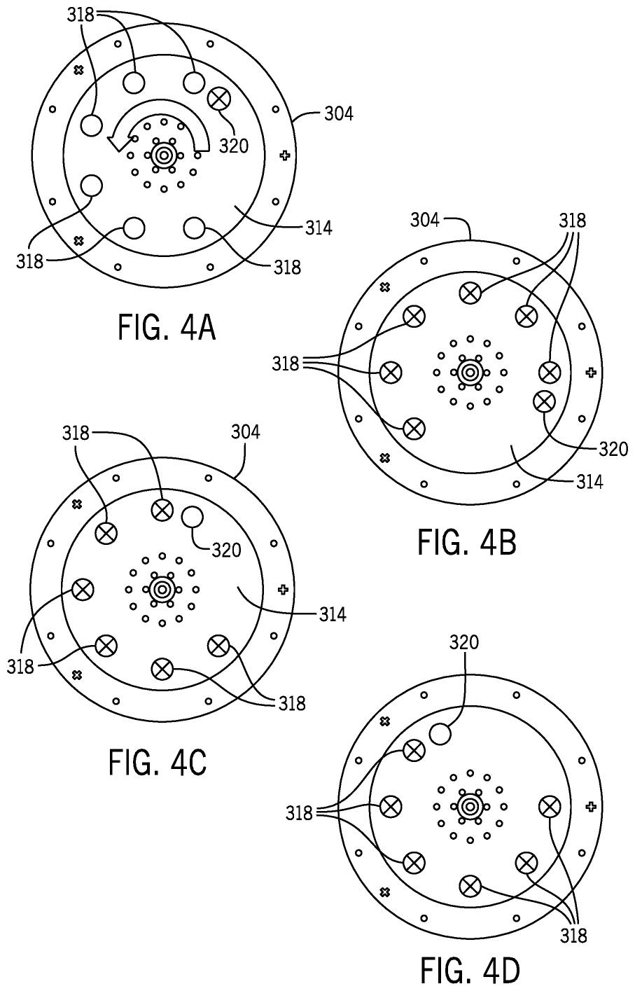

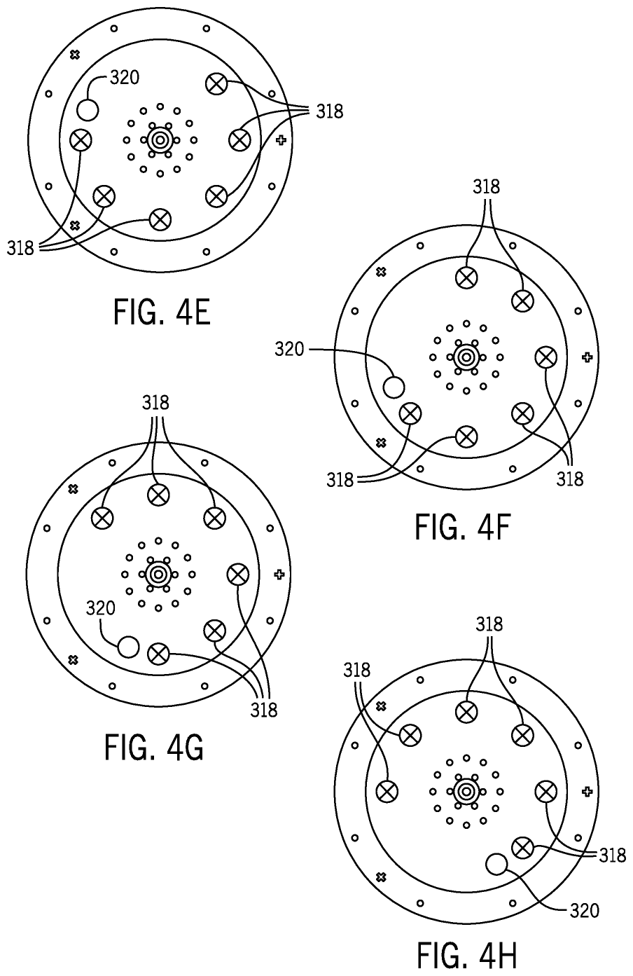

FIGS. 4A-4H illustrate various different settings of the isolation plate 314. In a fully open setting shown in FIG. 4A, the openings 318 of the isolation plate 314 are aligned with the respective valve ports 220, and thus, all of the valve ports 220 are fully open. The isolation plate 314 can be rotated, such as in a counterclockwise direction. In other examples, the isolation plate 314 can be rotated in a clockwise direction.

In FIG. 4B, rotation of the isolation plate 314 causes the isolation plate 314 to be moved to a closed setting, where none of the openings 318 and 320 are aligned with the valve ports 220, and therefore, all of the valve ports 220 are closed. In other examples, the isolation plate 314 can be moved such that the isolation plate 314 partially opens the valve ports 220.

FIGS. 4C-4H illustrate successive incremental settings of the isolation plate 314, where the isolation plate 314 is incrementally moved to cause the opening 320 to be successively aligned with different ones of the valve ports 220. FIG. 4C shows the opening 320 aligned with a first valve port, such that a first valve port is open while the remaining valve ports are closed. FIG. 4D shows the opening 320 aligned with a second valve port, FIG. 4E shows the opening 320 aligned with a third valve port, FIG. 4F shows the opening aligned with a fourth valve port, FIG. 4G illustrates the opening 320 aligned with a fifth valve port, and FIG. 4H illustrates the opening 320 aligned with a sixth valve port. Each of FIGS. 4D-4H show respective different ones of the valve ports being open while remaining valve ports are closed.

In other examples, while the isolation plate 314 is actuated to set one of the valve ports to a fully open position, the isolation plate 314 can set the remaining openings to be partially open. In further examples, more than one opening can be set to an open position, while the remaining openings are set in a restricted flow position.

Actuating the isolation plate 314 to one of the incremental settings shown in FIGS. 4C-4H can be performed in response to a sensor 205 detecting that a respective conduit 216 is clogged. In some cases, multiple sensors 205 can detect that multiple respective conduits 216 are clogged.

For example, if a sensor 205 detects that the conduit connected to the fourth valve port is clogged, then a controller 240 (FIG. 2) of the 3D printing system can control the motor 312 (FIG. 3A) to actuate the isolation plate 314 to the incremental setting shown in FIG. 4F, where the opening 320 of the isolation plate 314 is aligned with the fourth valve port.

If multiple conduits 216 are clogged, then the controller 240 can control the motor 312 to actuate the isolation plate 314 to successive incremental settings corresponding to the multiple clogged conduits. For example, if the multiple clogged conduits correspond to the second and fifth valve ports, the isolation plate 314 can be actuated first to the incremental setting of FIG. 4D in an attempt to clear the clogged condition of the conduit connected to the second valve port. Next, the isolation plate 314 can be actuated to the incremental setting of FIG. 4G in an attempt to clear the clogged condition of the conduit connected to the fifth valve port.

By setting just a subset of the valve ports 220 to the fully open position, while the remaining valve port(s) 220 is (are) in a restricted flow position, an increased flow force (e.g., increased draw by the flow control system 226 of FIG. 2) can be applied to clogged conduit(s) 216. Applying an increased flow force to the clogged conduit(s) 102 can aid in unclogging the clogged conduit(s) 216.

In some examples, the controller 240 can maintain the isolation plate 314 at a specific incremental setting for a specified time duration (e.g., 5 minutes or another example time duration). This time duration is to provide an opportunity for the increased pressure draw of the open valve port to clear the respective clogged conduit. Alternatively, the controller 240 can maintain the isolation plate 314 at the specific incremental setting until the corresponding pressure 205 provides a measurement indicating that the corresponding conduit is no longer clogged.

In some examples, as shown in FIG. 2, the controller 240 can include a counter 242 of a number of times that unclogging of a particular conduit has been attempted. For example, there can be one counter per valve port, so that the controller 240 includes multiple counters 242. Each time the isolation plate 314 is set to an incremental setting corresponding to a particular valve port, the corresponding counter 242 is advanced (incremented or decremented). If the counter 242 reaches a specified threshold value, then that is an indication that something is wrong with the 3D printing system, since the corresponding conduit keeps clogging or the valve assembly is unable to unclog the corresponding conduit after several attempts. The controller 240 can send an alert to a user or other entity (a machine or a program) in response to a counter 242 advancing to the specified threshold value.

More generally, a counter 242 tracks a number of times a clogged condition is detected for a given conduit. The controller 240 provides an alert in response to a count of the counter 242 advancing to a predefined threshold.

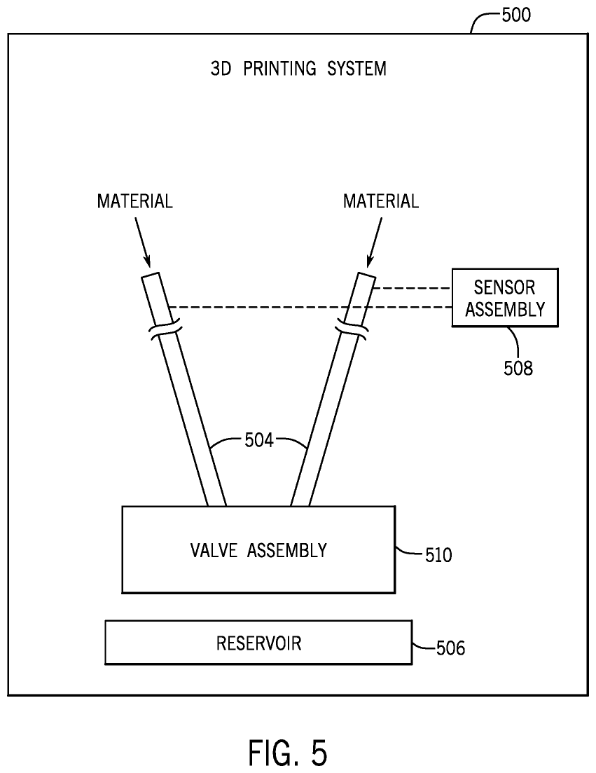

FIG. 5 is a block diagram of a simplified view of a 3D printing system 500 according to further examples. The 3D printing system 500 includes a build platform (not shown) to build a 3D object using a material. Multiple conduits 504 receive incidental material from the build platform. The conduits 504 are used to transport the incidental material to a reservoir 506.

A sensor assembly 508 measures pressures of respective conduits 504. A valve assembly 510 is connected to the conduits 504 to selectively control flow of the material through the conduits 504. The valve assembly 510 is controllable to actuate from a first setting to a second setting responsive to the sensor assembly 508 detecting a pressure of a first conduit of the multiple conduits 504 being outside a predefined range.

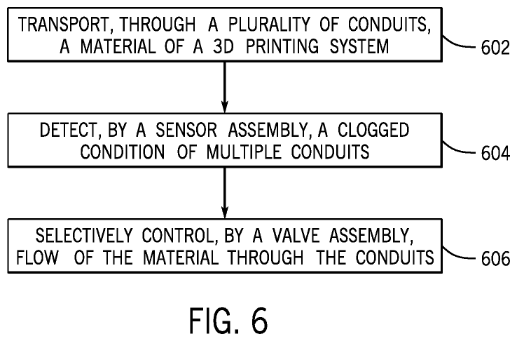

FIG. 6 is a flow diagram of a process according to some examples. The process includes transporting (at 602), through a plurality of conduits, a material of a 3D printing system between locations in the 3D printing system. The process includes detecting (at 604), by a sensor assembly, a clogged condition of multiple conduits. The process further includes selectively controlling (at 606), by a valve assembly, flow of the material through the conduits, where the valve assembly is controllable to actuate from a first setting to a second setting to unclog a first conduit, and from the second setting to a third setting to unclog a second conduit.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
a plurality of conduits to transport a material of a three-dimensional (3D) printing system between locations in the 3D printing system;
a sensor assembly to detect a clogged condition of a first conduit of the plurality of conduits; and
a valve assembly connected to the plurality of conduits to selectively control flow of the material through the plurality of conduits, the valve assembly controllable to actuate from a first setting to a second setting responsive to the detected clogged condition.

2. The apparatus of claim 1, wherein in the first setting the valve assembly is to set each of the plurality of conduits in an open position to allow flow of the material through the plurality of conduits, and wherein in the second setting the valve assembly is to set the first conduit in the open position, and to set another conduit of the plurality of conduits in a restricted flow position.

3. The apparatus of claim 2, further comprising a flow control system operatively coupled to the plurality of conduits to cause the flow of the material through the plurality of conduits when the valve assembly is in the first setting.

4. The apparatus of claim 3, wherein the flow control system is to apply a larger force on the first conduit when the valve assembly is in the second setting, the larger force to unclog the first conduit.

5. The apparatus of claim 4, wherein the flow control system comprises a vacuum source or an airflow generator.

6. The apparatus of claim 1, wherein the valve assembly comprises:
a plurality of valve ports connected to respective conduits of the plurality of conduits; and
a rotatable plate to rotate to a plurality of different positions, the plurality of different positions comprising a first position corresponding to the first setting, and a second position corresponding to the second setting.

7. The apparatus of claim 6, wherein in the first position the rotatable plate sets each of the plurality of valve ports to an open position, and wherein in the second position the rotatable plate sets a first valve port of the plurality of valve ports to the open position, and sets remaining valve ports other than the first valve port to a restricted flow position.

8. The apparatus of claim 7, wherein in a third position of the plurality of different positions, the rotatable plate sets a second valve port of the plurality of valve ports to the open position, and sets remaining valve ports other than the second valve port to a restricted flow position.

9. The apparatus of claim 1, wherein the sensor assembly comprises a plurality of sensors to detect pressures of respective conduits of the plurality of conduits, a pressure that is outside a predefined pressure range indicating a clogged condition of a respective conduit.

10. The apparatus of claim 1, further comprising:
a counter to track a number of times a clogged condition is detected for a given conduit of the plurality of conduits; and
a controller to provide an alert in response to a count of the counter advancing to a predefined threshold.

11. A three-dimensional (3D) printing system comprising:
a plurality of conduits to receive incidental material from a build platform on which a 3D object is to be build using a material;
a sensor assembly to measure pressures of respective conduits of the plurality of conduits; and
a valve assembly connected to the plurality of conduits to selectively control flow of the incidental material through the plurality of conduits, the valve assembly controllable to actuate from a first setting to a second setting responsive to the sensor assembly detecting a pressure of a first conduit of the plurality of conduits being outside a predefined range.

12. The 3D printing system of claim 11, wherein the valve assembly when set at the second setting is to cause unclogging of the first conduit.

13. The 3D printing system of claim 12, further comprising a flow control system connected to the plurality of conduits, and to cause flow of the incidental material through each conduit of the plurality of conduits that is in an open position as set by the valve assembly.

14. A method comprising:
transporting, through a plurality of conduits using a flow control system, a material of a three-dimensional (3D) printing system between locations in the 3D printing system;
detecting, by a sensor assembly, a clogged condition of multiple conduits of the plurality of conduits; and
selectively controlling, by a valve assembly connected to the plurality of conduits, flow of the material in gas through the plurality of conduits, the valve assembly controllable to actuate from a first setting to a second setting to unclog a first conduit of the multiple conduits, and from the second setting to a third setting to unclog a second conduit of the multiple conduits.

15. The method of claim 14, wherein selectively controlling the valve assembly comprises rotating a rotatable plate from the first setting to the second setting, and from the second setting to the third setting.
